(19) United States
(12) Patent Application Publication
(10) Pub. No.: US 2026/0258876 A1
(43) Pub. Date: Sep. 3, 2026

(54) Five-Way Valve

(71) Applicant: ZHEJIANG DUNAN ARTIFICIAL ENVIRONMENT CO., LTD., Shaoxing, Zhejiang (CN)

(72) Inventors: Zhongbo FENG, Shaoxing, Zhejiang (CN); Junjie WANG, Shaoxing, Zhejiang (CN); Haijian SHA, Shaoxing, Zhejiang (CN); Fugang WANG, Shaoxing, Zhejiang (CN)

(21) Appl. No.: 18/718,027

(22) PCT Filed: May 17, 2022
(86) PCT No.: PCT/CN2022/093314

§ 371 Date: Jun. 8, 2024

(30) Foreign Application Priority Data
Dec. 10, 2021 (CN) 202111511104.5
Dec. 10, 2021 (CN) 202123098867.X

(51) Int. Cl. F16K 11/085; F16K 31/04

(52) U.S. Cl. CPC F16K 11/0856; F16K 11/085; F16K 31/047

(57) ABSTRACT

Provided is a five-way valve, including: a main body portion, the main body portion having a valve cavity, a first inlet, a second inlet a first outlet a second outlet, a third outlet, and a fourth outlet; a valve core rotatably arranged in the valve cavity, the valve core having a first cavity, a second cavity, a third cavity, and a fourth cavity which are separated; and a single-motor actuator, the single-motor actuator being in driving connection with the valve core, wherein the five-way valve can be switched to any one of a first working condition, a second working condition, a third working condition, a fourth working condition, a fifth working condition, and a sixth working condition by means of rotation of the valve core.

### CROSS-REFERENCE TO RELATED APPLICATION

The present disclosure is a national stage application of International Patent Application No. PCT/CN2022/093314, which is filed on May 17, 2022. The International Patent Application claims the priority of Chinese Application No. 202111511104.5, filed in the Chinese Patent Office on Dec. 10, 2021, and entitled “Five-Way Valve” and claims the priority of Chinese Application No. 202123098867.X, filed in the Chinese Patent Office on Dec. 10, 2021, and entitled “Five-Way Valve”.

### TECHNICAL FIELD

The present disclosure relates to the technical field of five-way valves, specifically to a five-way valve.

### BACKGROUND

Currently, for multi-way valves in a prior art, a plurality of motors and valve cores are required to achieve the switching between multiple working conditions. Taking a five-way valve as an example, the five-way valve in the prior art usually uses two valve cores and two motors, and the two motors respectively drive the two valve cores to rotate. The switching between multiple working conditions of the five-way valve and the flow rate adjustment can be achieved by rotation of the valve core.

The five-way valve in the prior art requires two valve cores and two motors to achieve working condition switching and flow rate adjusting functions, there are more structures, the production and manufacturing difficulty is higher, the mounting accuracy is difficult to ensure during a mounting process, and the cost is high.

### SUMMARY

Some embodiments of the present disclosure provide a five-way valve to solve the problem of high manufacturing cost of five-way valves in the prior art.

In order to solve the above problem, some embodiments of the present disclosure provide a five-way valve, including: a main body portion, the main body portion having a valve cavity, a first inlet, a second inlet, a first outlet, a second outlet, a third outlet, and a fourth outlet; a valve core rotatably arranged in the valve cavity, the valve core having a first cavity, a second cavity, a third cavity, and a fourth cavity which are separated; and a single-motor actuator, the single-motor actuator being in driving connection with the valve core, wherein the five-way valve can be switched to any one of the following working conditions by means of rotation of the valve core: a first working condition: the first inlet is communicated with the first outlet through the first cavity, the second inlet is communicated with the third outlet through the third cavity, and the second outlet and the fourth outlet are disconnected; a second working condition: the first inlet is communicated with the first outlet through the first cavity, the second inlet is communicated with both the third outlet and the fourth outlet through the third cavity, and the second outlet is disconnected; a third working condition: the first inlet is communicated with the first outlet through the first cavity, the second inlet is communicated with the fourth outlet through the third cavity, and both the third outlet and the second outlet are disconnected; a fourth working condition: the second inlet is communicated with the second outlet through the second cavity, the first inlet is communicated with the third outlet through the fourth cavity, and both the first outlet and the fourth outlet are disconnected; a fifth working condition: the second inlet is communicated with the second outlet through the second cavity, the first inlet is communicated with both the third outlet and the fourth outlet through the fourth cavity, and the first outlet is disconnected; and a sixth working condition: the second inlet is communicated with the second outlet through the second cavity, the first inlet is communicated with the fourth outlet through the fourth cavity, and the first outlet and the third outlet are disconnected.

Further, in the second working condition, the single-motor actuator is configured to drive the valve core to rotate and maintain at multiple different positions to adjust a proportion of fluids output from the third outlet and the fourth outlet; and in the fifth working condition, the single-motor actuator is configured to drive the valve core to rotate and maintain at multiple different positions to adjust a proportion of fluids output from the third outlet and the fourth outlet. Further, the valve core includes a first axial region, a second axial region, and a third axial region which are sequentially arranged in an axial direction, and openings of the first cavity, the second cavity, the third cavity, and the fourth cavity all face an inner wall of the valve cavity; and the first cavity includes a first-first main cavity and a first-second main cavity which are communicated with each other, the third cavity includes a third-first main cavity and a third-second main cavity which are communicated with each other, the second cavity includes a second-first main cavity and a second-second main cavity which are communicated with each other, and the fourth cavity includes a fourth-first main cavity and a fourth-second main cavity which are communicated with each other, wherein the first-first main cavity and the second-first main cavity are both located in the first axial region, the first-second main cavity, the third-first main cavity, the fourth-first main cavity, and the second-second main cavity are all located in the second axial region, and the third-second main cavity and the fourth-second main cavity are both arranged in the third axial region.

Further, the valve core includes a first fan-shaped region, a second fan-shaped region, a third fan-shaped region, a fourth fan-shaped region, a fifth fan-shaped region, a sixth fan-shaped region, a seventh fan-shaped region, and an eighth fan-shaped region which are sequentially arranged in a circumferential direction, wherein the first-first main cavity is distributed in the first fan-shaped region and the second fan-shaped region, the first-second main cavity is distributed in the first fan-shaped region and the second fan-shaped region, the third-first main cavity is distributed in the third fan-shaped region and the fourth fan-shaped region, the third-second main cavity is distributed in the second fan-shaped region and the third fan-shaped region, the second-first main cavity is distributed in the seventh fan-shaped region and the eighth fan-shaped region, the second-second main cavity is distributed in the seventh fan-shaped region and the eighth fan-shaped region, the fourth-first main cavity is distributed in the fifth fan-shaped region and the sixth fan-shaped region, and the fourth-second main cavity is distributed in the sixth fan-shaped region and the seventh fan-shaped region.

Further, in the axial direction of the valve core, lengths of the first axial region, the second axial region, and the third axial region are equal; and in the circumferential direction of the valve core, radians of the first fan-shaped region, the second fan-shaped region, the third fan-shaped region, the fourth fan-shaped region, the fifth fan-shaped region, the sixth fan-shaped region, the seventh fan-shaped region, and the eighth fan-shaped region are equal.

Further, in a circumferential direction of the valve core, opening angles of the third outlet and the fourth outlet are both H1, a spacing angle between the third outlet and the fourth outlet is H2, and opening angles of the third-second main cavity and the fourth-second main cavity are both H3, wherein H1<H2<H3.

Further, the valve core includes a shaft sleeve, two circular end plates, a plurality of axial partition plates, and a plurality of fan-shaped partition plates, the two circular end plates are arranged in parallel and are both fixedly connected with the shaft sleeve, and the two circular end plates and the shaft sleeve are both coaxially arranged, wherein the plurality of axial partition plates and the plurality of fan-shaped partition plates are distributed in a space between the two circular end plates to divide the space between the two circular end plates into the first cavity, the second cavity, the third cavity, and the fourth cavity, and the single-motor actuator is in driving connection with the shaft sleeve.

Further, each of the plurality of axial partition plates and each of the plurality of fan-shaped partition plates are both connected with the shaft sleeve, and the each of the plurality of fan-shaped partition plates is connected with at least two axial partition plates in the plurality of axial partition plates; the third-second main cavity includes a first sub-cavity and a second sub-cavity which are communicated with each other, the fourth-second main cavity includes a third sub-cavity and a fourth sub-cavity which are communicated with each other, and the valve core further includes a first arc-shaped plate and a second arc-shaped plate; in the circumferential direction of the valve core, the first arc-shaped plate, the first sub-cavity, the second sub-cavity, the second arc-shaped plate, the third sub-cavity, and the fourth sub-cavity are sequentially arranged; in the first working condition, the first sub-cavity is connected to the third outlet, and the second arc-shaped plate blocks the fourth outlet; in the third working condition, the second sub-cavity is connected to the fourth outlet, and the first arc-shaped plate blocks the third outlet; in the fourth working condition, the third sub-cavity is connected to the third outlet, and the first arc-shaped plate blocks the fourth outlet; and in the sixth working condition, the fourth sub-cavity is connected to the fourth outlet, and the second arc-shaped plate blocks the third outlet.

Further, a bottom wall of the valve cavity is provided with an arc-shaped groove, the arc-shaped groove is arranged around an axis of the valve core, the five-way valve further includes a limiting block, the limiting block is located on a side of the valve core facing the bottom wall of the valve cavity, and the limiting block is located in the arc-shaped groove.

Further, the arc-shaped groove has a first arc-shaped wall, a second arc-shaped wall, a first end wall, and a second end wall, the limiting block has a fan-shaped structure, and the limiting block has a third arc-shaped wall, a fourth arc-shaped wall, a third end wall, and a fourth end wall, wherein the first arc-shaped wall is matched with the third arc-shaped wall, the second arc-shaped wall is matched with the fourth arc-shaped wall, the first end wall is in stop fit with the third end wall, and the second end wall is in stop fit with the fourth end wall.

Further, the valve core has a first setting position and a second setting position; in a case that the valve core is located in the first setting position, the five-way valve is in the first working condition, and the first end wall is separated from the third end wall; in a case that the valve core is located in the second setting position, the five-way valve is in the sixth working condition, and the second end wall is separated from the fourth end wall; and in a case that the five-way valve is switched from the first working condition to the sixth working condition along a rotation direction, a rotation angle of the valve core is N, and a range of a rotation angle of the limiting block in the arc-shaped groove is greater than N.

Further, the valve core has a first setting position; in a case that the valve core is located in the first setting position, the five-way valve is in the first working condition, and the valve core has a reserved rotation angle M; in a case that the valve core rotates in a range of the rotation angle M along a rotation direction from the first setting position, the five-way valve is maintained in the first working condition; and in a case that the valve core rotates in a range greater than the rotation angle M along the rotation direction from the first setting position, the five-way valve is switched to other working conditions.

Further, the main body portion includes a valve body and a sealing gasket, the valve body has the valve cavity, the sealing gasket is arranged in the valve cavity, and the first inlet, the second inlet, the first outlet, the second outlet, the third outlet, and the fourth outlet are all arranged in the sealing gasket, wherein the first outlet, the first inlet, and the third outlet are arranged along an axial direction of the valve core, the second outlet, the second inlet, and the fourth outlet are arranged along the axial direction of the valve core, the first outlet and the second outlet are arranged along the circumferential direction of the valve core, the first inlet and the second inlet are arranged along the circumferential direction of the valve core, and the third outlet and the fourth outlet are arranged along the circumferential direction of the valve core.

Further, the sealing gasket has an arc-shaped structure, an outer side of the sealing gasket is attached to an inner wall of the valve cavity, an inner side of the sealing gasket is attached to an outer circumferential surface of the valve core, the main body portion further includes two arc-shaped baffle plates arranged on the inner wall of the valve cavity, and the two arc-shaped baffle plates respectively abut against two ends of the sealing gasket in a circumferential direction; and on a side of the sealing gasket facing the inner wall of the valve cavity, the sealing gasket is distributed with a plurality of sealing ribs in the axial direction and the circumferential direction.

Further, the valve body includes a base, a cylinder, and a plurality of reinforcing ribs, the cylinder is connected with the base, each of the plurality of reinforcing ribs is connected with both the base and an outer wall of the cylinder, the cylinder has the valve cavity, the base has six flow channels, and the six flow channels are respectively communicated with the first inlet, the second inlet, the first outlet, the second outlet, the third outlet, and the fourth outlet.

Further, the main body portion further includes a valve cover and a sealing ring, the valve cover is in sealed connection with the valve body, the valve cover blocks an opening of the valve cavity, the sealing ring is arranged in a groove of the valve cover, the five-way valve further includes a rotating shaft, a portion of the rotating shaft is fixed in the valve core, the rotating shaft passes through the sealing ring, and an output shaft of the single-motor actuator is in driving connection with the rotating shaft.

Further, the single-motor actuator includes a housing and a motor, a gear assembly, and a control plate which are arranged in the housing, the motor is in driving connection with an input shaft of the gear assembly, an output shaft of the gear assembly is in driving connection with the valve core, and the housing is fixedly connected with the main body portion.

The technical solution of the present disclosure provides a five-way valve, including: a main body portion, the main body portion having a valve cavity, a first inlet, a second inlet, a first outlet, a second outlet, a third outlet, and a fourth outlet; a valve core rotatably arranged in the valve cavity, the valve core having a first cavity, a second cavity, a third cavity, and a fourth cavity which are separated; and a single-motor actuator, the single-motor actuator being in driving connection with the valve core, wherein the five-way valve can be switched to any one of the following working conditions by means of rotation of the valve core: a first working condition: the first inlet is communicated with the first outlet through the first cavity, the second inlet is communicated with the third outlet through the third cavity, and the second outlet and the fourth outlet are disconnected; a second working condition: the first inlet is communicated with the first outlet through the first cavity, the second inlet is communicated with both the third outlet and the fourth outlet through the third cavity, and the second outlet is disconnected; a third working condition: the first inlet is communicated with the first outlet through the first cavity, the second inlet is communicated with the fourth outlet through the third cavity, and the third outlet and the second outlet are disconnected; a fourth working condition: the second inlet is communicated with the second outlet through the second cavity, the first inlet is communicated with the third outlet through the fourth cavity, and the first outlet and the fourth outlet are disconnected; a fifth working condition: the second inlet is communicated with the second outlet through the second cavity, the first inlet is communicated with both the third outlet and the fourth outlet through the fourth cavity, and the first outlet is disconnected; and a sixth working condition: the second inlet is communicated with the second outlet through the second cavity, the first inlet is communicated with the fourth outlet through the fourth cavity, and the first outlet and the third outlet are disconnected. By means of this solution, the switching between multiple working conditions of the five-way valve can be achieved by using one single-motor actuator to drive one valve core to rotate. Compared with the situation in the prior art that the switching between working conditions of the five-way valve can be achieved only by using two motors to respectively drive two valve cores, this solution of the present disclosure reduces a set of single-motor actuator and valve core, thereby reducing the production and manufacturing difficulty of the five-way valve, improving the mounting accuracy of the overall structure of the five-way valve, and reducing the manufacturing cost of the five-way valve.

### BRIEF DESCRIPTION OF THE DRAWINGS

The accompanying drawings of the specification, constituting a part of the present disclosure, are used for providing a further understanding for the present disclosure. Exemplary embodiments of the present disclosure and descriptions thereof are used for explaining the present disclosure, but do not constitute any improper limitation on the present disclosure. In the accompanying drawings:

FIG. 1 shows a schematic structural view of a five-way valve provided in an embodiment of the present disclosure;

FIG. 2 shows an exploded view of the five-way valve in FIG. 1;

FIG. 3 shows an exploded view of partial structures in the five-way valve in FIG. 1;

FIG. 4 shows a schematic structural view of a valve body of the five-way valve in FIG. 1;

FIG. 5 shows a bottom view of the five-way valve in FIG. 1;

FIG. 6 shows a schematic structural view of a valve core of the five-way valve in FIG. 1;

FIG. 7 shows a schematic structural view of the valve core in FIG. 6 from another perspective;

FIG. 8 shows a circumferentially expanded schematic view of the valve core in FIG. 6;

FIG. 9 shows a region division schematic view of the valve core in FIG. 8;

FIG. 10 shows a schematic structural view of a sealing gasket of the five-way valve in FIG. 1;

FIG. 11 shows a cross-sectional view of the sealing gasket in FIG. 8;

FIG. 12 shows a side view of a main body portion and the valve core of the five-way valve in FIG. 1;

FIG. 13 shows a cross-sectional view of a position D-D in FIG. 12;

FIG. 14 shows a cross-sectional view of a position E-E in FIG. 12;

FIG. 15 shows a cross-sectional view of a position F-F in FIG. 12;

FIG. 16 shows a cross-sectional view of a position G-G in FIG. 12; and

FIG. 17 shows a schematic structural view of a single-motor actuator of the five-way valve in FIG. 1.

The above accompanying drawings have the following reference numerals:

10. main body portion; 111. second outlet; 112. first outlet; 113. first inlet; 114. second inlet; 115. third outlet; 116. fourth outlet; 12. valve cavity; 13. arc-shaped groove; 14. valve body; 141. base; 142. cylinder; 143. reinforcing rib; 144. metal sleeve; 15. sealing gasket; 16. arc-shaped baffle plate; 17. valve cover; 18. sealing ring; 19. flat washer;

20. valve core; 21. first cavity; 211. first-first main cavity; 212. first-second main cavity; 22. second cavity; 221. second-first main cavity; 222. second-second main cavity; 23. third cavity; 231. third-first main cavity; 232. third-second main cavity; 24. fourth cavity; 241. fourth-first main cavity; 242. fourth-second main cavity; 251. first axial region; 252. second axial region; 253. third axial region; 261. first fan-shaped region; 262. second fan-shaped region; 263. third fan-shaped region; 264. fourth fan-shaped region; 265. fifth fan-shaped region; 266. sixth fan-shaped region; 267. seventh fan-shaped region; 268. eighth fan-shaped region; 271. shaft sleeve; 272. circular end plate; 273. axial partition plate; 274. fan-shaped partition plate; 281. first arc-shaped plate; 282. second arc-shaped plate;
30. single-motor actuator; 31. housing; 32. motor; 33. gear assembly; 34. control plate;
40. limiting block;
50. rotating shaft;
C2. first sub-cavity; C3. second sub-cavity; C6. third sub-cavity; C7. fourth sub-cavity.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are only some embodiments rather than all the embodiments of the present disclosure. The following description of at least one exemplary embodiment is actually only illustrative, and does not constitute any limitation on the present disclosure and the application or use of the present disclosure. All other embodiments obtained by those of ordinary skill in the art based on the embodiments in the present disclosure without creative efforts shall fall within the protection scope of the present disclosure.

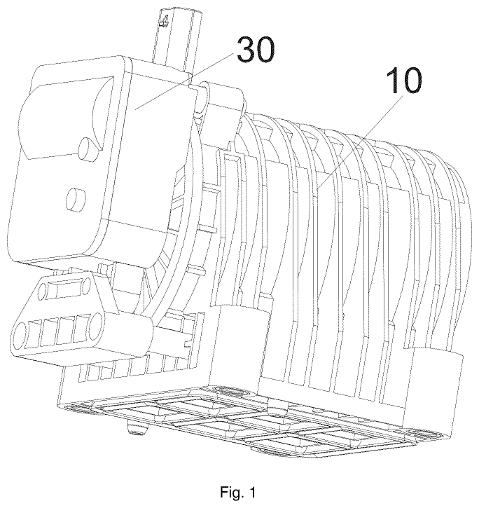

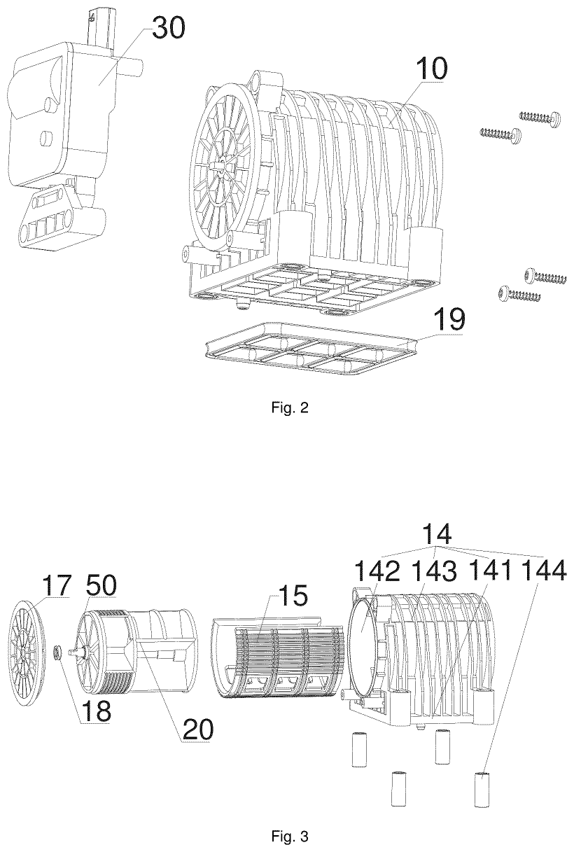

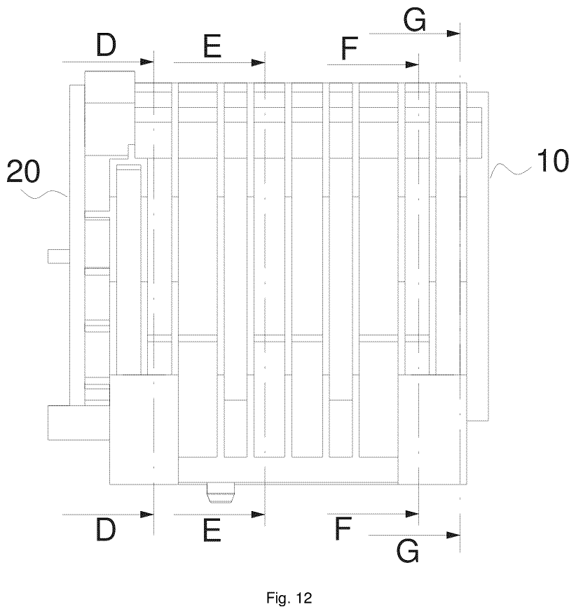

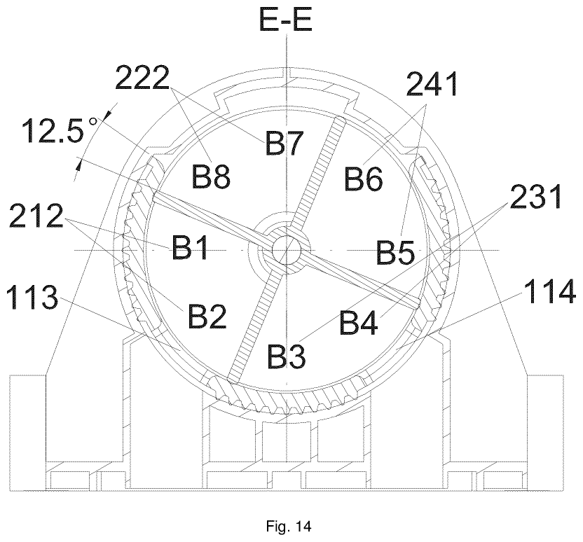

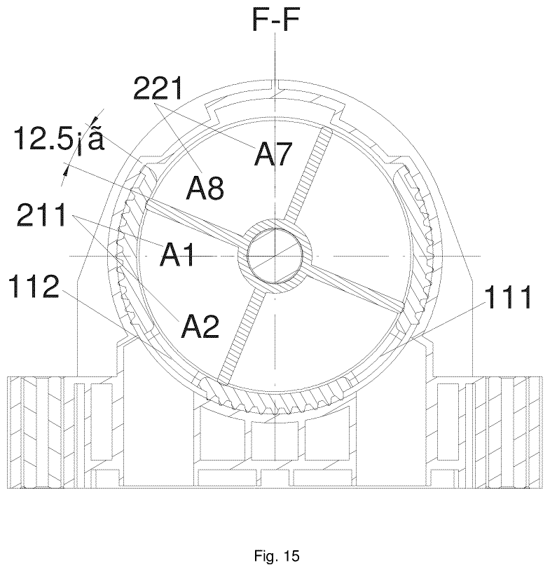

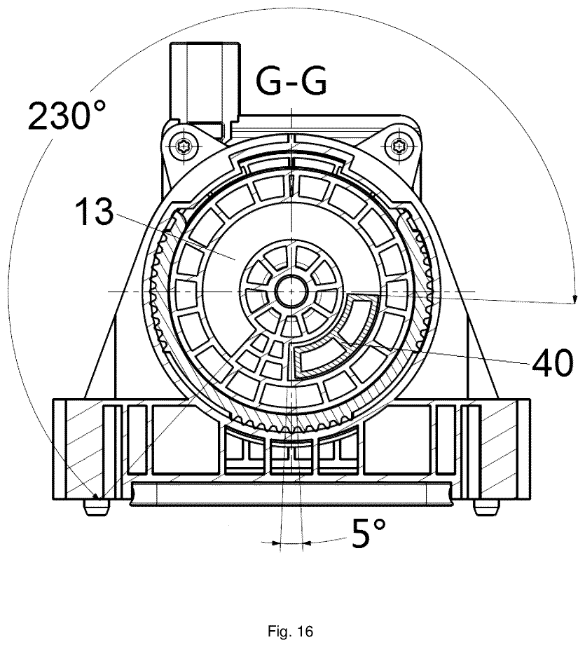

As shown in FIG. 1 to FIG. 17, an embodiment of the present disclosure provides a five-way valve, including: a main body portion 10, the main body portion 10 has a valve cavity 12, a first inlet 113, a second inlet 114, a first outlet 112, a second outlet 111, a third outlet 115, and a fourth outlet 116; a valve core 20 rotatably arranged in the valve cavity 12, the valve core 20 has a first cavity 21, a second cavity 22, a third cavity 23, and a fourth cavity 24 which are separated; and a single-motor actuator 30, the single-motor actuator 30 is in driving connection with the valve core 20, wherein the five-way valve can be switched to any one of the following working conditions by means of rotation of the valve core 20: a first working condition: the first inlet 113 is communicated with the first outlet 112 through the first cavity 21, the second inlet 114 is communicated with the third outlet 115 through the third cavity 23, and the second outlet 111 and the fourth outlet 116 are disconnected; a second working condition: the first inlet 113 is communicated with the first outlet 112 through the first cavity 21, the second inlet 114 is communicated with both the third outlet 115 and the fourth outlet 116 through the third cavity 23, and the second outlet 111 is disconnected; a third working condition: the first inlet 113 is communicated with the first outlet 112 through the first cavity 21, the second inlet 114 is communicated with the fourth outlet 116 through the third cavity 23, and the third outlet 115 and the second outlet 111 are disconnected; a fourth working condition: the second inlet 114 is communicated with the second outlet 111 through the second cavity 22, the first inlet 113 is communicated with the third outlet 115 through the fourth cavity 24, and the first outlet 112 and the fourth outlet 116 are disconnected; a fifth working condition: the second inlet 114 is communicated with the second outlet 111 through the second cavity 22, the first inlet 113 is communicated with both the third outlet 115 and the fourth outlet 116 through the fourth cavity 24, and the first outlet 112 is disconnected; and a sixth working condition: the second inlet 114 is communicated with the second outlet 111 through the second cavity 22, the first inlet 113 is communicated with the fourth outlet 116 through the fourth cavity 24, and the first outlet 112 and the third outlet 115 are disconnected.

In this embodiment, the switching between multiple working conditions of the five-way valve can be achieved by using one single-motor actuator 30 to drive one valve core 20 to rotate. Compared with the situation in a prior art that the switching between working conditions of the five-way valve can be achieved only by using two motors to respectively drive two valve cores 20, this solution reduces a set of motor and valve core 20, thereby reducing the production and manufacturing difficulty of the five-way valve, improving a mounting accuracy of the overall structure of the five-way valve, and reducing a manufacturing cost of the five-way valve.

Specifically, in the second working condition, the single-motor actuator 30 is able to drive the valve core 20 to rotate and maintain at multiple different positions to adjust the proportion of fluids output from the third outlet 115 and the fourth outlet 116; and in the fifth working condition, the single-motor actuator 30 is able to drive the valve core 20 to rotate and maintain at multiple different positions to adjust the proportion of fluids output from the third outlet 115 and the fourth outlet 116.

In this embodiment, a flow rate of the outlet of the five-way valve in the second working condition and the fifth working condition is adjusted by using one single-motor actuator 30 to drive one valve core 20 to rotate. Compared with the situation in the prior art that the adjustment of the flow rate of the outlet of the five-way valve is achieved by using two motors to respectively drive two valve cores 20 to rotate, this solution reduces a set of motor and valve core 20, thereby reducing the production and manufacturing difficulty and manufacturing cost of the five-way valve.

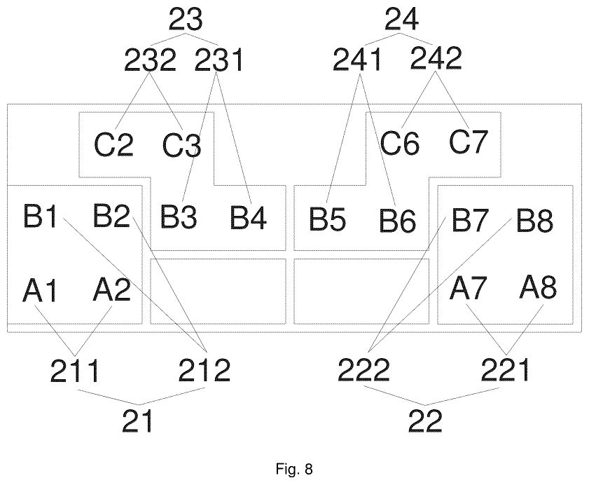

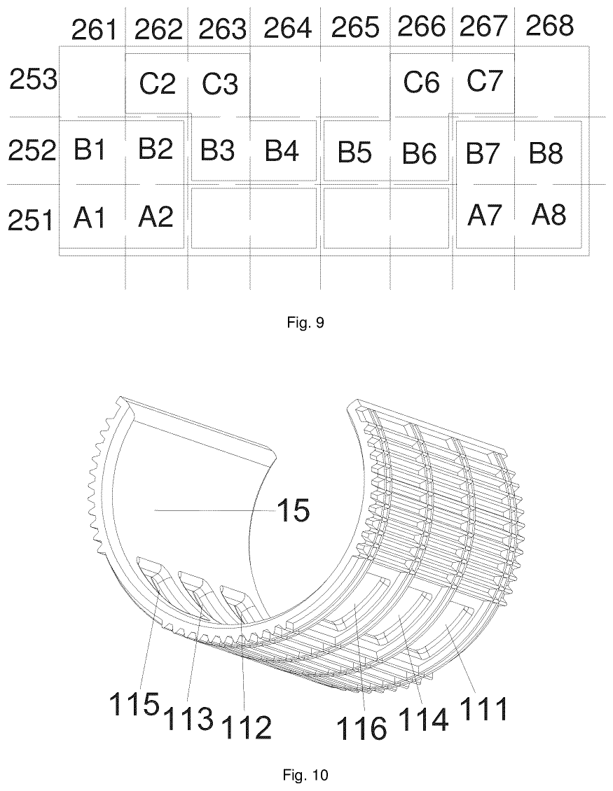

As shown in FIG. 8 and FIG. 9, the valve core 20 includes a first axial region 251, a second axial region 252, and a third axial region 253 which are sequentially arranged in an axial direction, and openings of the first cavity 21, the second cavity 22, the third cavity 23, and the fourth cavity 24 all face an inner wall of the valve cavity 12; and the first cavity 21 includes a first-first main cavity 211 and a first-second main cavity 212 which are communicated with each other, the third cavity 23 includes a third-first main cavity 231 and a third-second main cavity 232 which are communicated with each other, the second cavity 22 includes a second-first main cavity 221 and a second-second main cavity 222 which are communicated with each other, and the fourth cavity 24 includes a fourth-first main cavity 241 and a fourth-second main cavity 242 which are communicated with each other, wherein the first-first main cavity 211 and the second-first main cavity 221 are both located in the first axial region 251, the first-second main cavity 212, the third-first main cavity 231, the fourth-first main cavity 241, and the second-second main cavity 222 are all located in the second axial region 252, and the third-second main cavity 232 and the fourth-second main cavity 242 are both arranged in the third axial region 253.

In this embodiment, a plurality of cavities for achieving a flow rate adjusting function and a working condition switching function of the five-way valve are arranged on the same valve core 20, that is, the valve core 20 is divided into three layers: the first axial region 251, the second axial region 252, and the third axial region 253, and the plurality of cavities with circulation relationships, namely the first cavity 21, the second cavity 22, the third cavity 23, and the fourth cavity 24, are limited on the first axial region 251, the second axial region 252, and the third axial region 253. By this arrangement, two communication segments which are communicated with each other in each cavity can be separated in the axial direction, and the communication between different cavities and different inlets and outlets can be achieved by means of rotation of the valve core 20, thereby achieving the purposes of working condition switching and flow rate adjustment. Compared with the situation in the prior art that the flow rate adjustment and working condition switching of the five-way valve can be achieved by means of rotation of two valve cores, this embodiment of the present disclosure combines the functions of two valve cores to form a new valve core 20, thereby reducing the production cost of the five-way valve.

As shown in FIG. 8 and FIG. 9, the valve core 20 includes a first fan-shaped region 261, a second fan-shaped region 262, a third fan-shaped region 263, a fourth fan-shaped region 264, a fifth fan-shaped region 265, a sixth fan-shaped region 266, a seventh fan-shaped region 267, and an eighth fan-shaped region 268 which are sequentially arranged in a circumferential direction, wherein the first-first main cavity 211 is distributed in the first fan-shaped region 261 and the second fan-shaped region 262, the first-second main cavity 212 is distributed in the first fan-shaped region 261 and the second fan-shaped region 262, the third-first main cavity 231 is distributed in the third fan-shaped region 263 and the fourth fan-shaped region 264, the third-second main cavity 232 is distributed in the second fan-shaped region 262 and the third fan-shaped region 263, the second-first main cavity 221 is distributed in the seventh fan-shaped region 267 and the eighth fan-shaped region 268, the second-second main cavity 222 is distributed in the seventh fan-shaped region 267 and the eighth fan-shaped region 268, the fourth-first main cavity 241 is distributed in the fifth fan-shaped region 265 and the sixth fan-shaped region 266, and the fourth-second main cavity 242 is distributed in the sixth fan-shaped region 266 and the seventh fan-shaped region 267.

In this embodiment, a plurality of cavities for achieving a flow rate adjusting function and a working condition switching function of the five-way valve are arranged on the same valve core 20, that is, the valve core 20 is divided into eight columns: the first fan-shaped region 261, the second fan-shaped region 262, the third fan-shaped region 263, the fourth fan-shaped region 264, the fifth fan-shaped region 265, the sixth fan-shaped region 266, the seventh fan-shaped region 267, and the eighth fan-shaped region 268, and the plurality of cavities with circulation relationships are limited in the plurality of fan-shaped regions. By this arrangement, two communication segments which are communicated with each other in each cavity can be separated in the radial direction, and the communication between different cavities and different inlets and outlets can be achieved by means of rotation of the valve core 20, thereby achieving the purposes of working condition switching and flow rate adjustment. Compared with the situation in the prior art that the function of the five-way valve can be achieved by means of rotation of two valve cores, this embodiment combines the functions of two valve cores to form a new valve core 20, thereby reducing the production cost of the five-way valve.

In some embodiments, in the axial direction of the valve core 20, the lengths of the first axial region 251, the second axial region 252, and the third axial region 253 are equal; and in the circumferential direction of the valve core 20, the radians of the first fan-shaped region 261, the second fan-shaped region 262, the third fan-shaped region 263, the fourth fan-shaped region 264, the fifth fan-shaped region 265, the sixth fan-shaped region 266, the seventh fan-shaped region 267, and the eighth fan-shaped region 268 are equal.

In an embodiment, by limiting the lengths of the first axial region 251, the second axial region 252, and the third axial region 253 to be equal, the communication areas between the cavity on each axial region and the inlet and outlet of the main body portion 10 are limited to be equal, thereby preventing the situation that the flow rates of the inlet and outlet of the five-way valve are different due to unequal communication areas between different axis regions and the inlet and outlet. By limiting the radians of the plurality of fan-shaped regions to be equal, the rotation angle of each fan-shaped region corresponding to the valve core 20 is ensured to be equal, thereby ensuring the rotation reliability of the valve core 20.

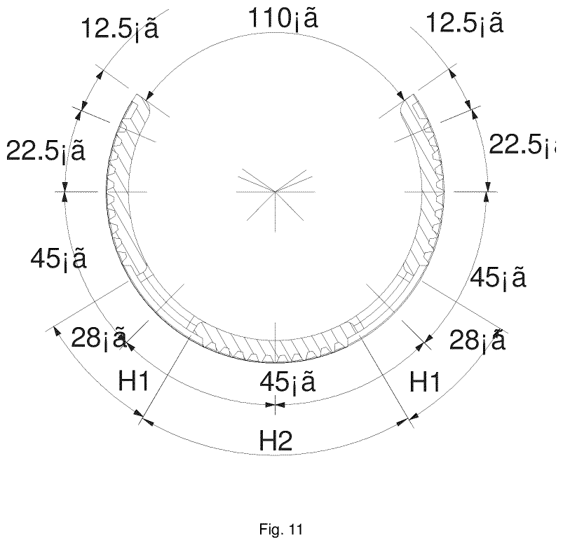

As shown in FIG. 11, in the circumferential direction of the valve core 20, the opening angles of the third outlet 115 and the fourth outlet 116 are both H1, the spacing angle between the third outlet 115 and the fourth outlet 116 is H2, and the opening angles of the third-second main cavity 232 and the fourth-second main cavity 242 are both H3, wherein H1<H2<H3. By this arrangement, because H3>H2, it can be ensured that when the valve core 20 rotates a certain angle, the third outlet 115 and the fourth outlet 116 can be communicated simultaneously to ensure the performance of the five-way valve.

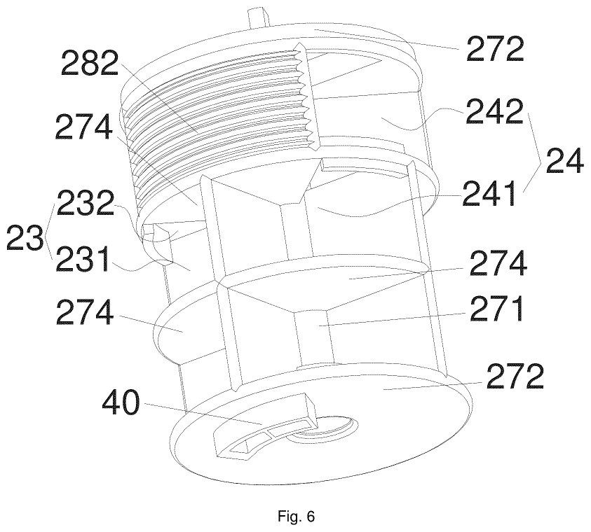

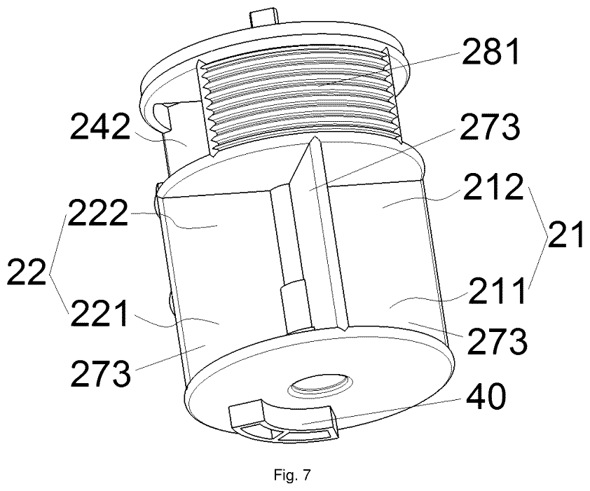

As shown in FIG. 6 and FIG. 7, the valve core 20 includes a shaft sleeve 271, two circular end plates 272, a plurality of axial partition plates 273, and a plurality of fan-shaped partition plates 274, the two circular end plates 272 are arranged in parallel and are both fixedly connected with the shaft sleeve 271, and the two circular end plates 272 and the shaft sleeve 271 are both coaxially arranged, wherein the plurality of axial partition plates 273 and the plurality of fan-shaped partition plates 274 are distributed in a space between the two circular end plates 272 to divide the space between the two circular end plates 272 into the first cavity 21, the second cavity 22, the third cavity 23, and the fourth cavity 24, and the single-motor actuator 30 is in driving connection with the shaft sleeve 271.

In an embodiment, the shaft sleeve 271 and the circular end plates 272 at two ends form a main body of the valve core 20, and then, an internal space of the main body of the valve core 20 is divided into the first cavity 21, the second cavity 22, the third cavity 23, and the fourth cavity 24 by the plurality of axial partition plates 273 and the plurality of fan-shaped partition plates 274 in the axial direction and the radial direction to form the valve core 20. By this arrangement, it can be ensured that main cavities which are communicated with each other in each cavity can be separated in both the axial direction and radial direction of the valve core 20, and the first cavity 21, the second cavity 22, the third cavity 23, and the fourth cavity 24 can also be separated in the axial direction and radial direction of the valve core 20, thereby ensuring the performance of the valve core 20.

In some embodiments, at least one circular end plate 272 is provided with ribs to increase the structural strength of the valve core 20.

In some embodiments, each axial partition plate 273 and each fan-shaped partition plate 274 are both connected with the shaft sleeve 271, and the each fan-shaped partition plate 274 is connected with at least two axial partition plates 273; the third-second main cavity 232 includes a first sub-cavity C2 and a second sub-cavity C3 which are communicated with each other, the fourth-second main cavity 242 includes a third sub-cavity C6 and a fourth sub-cavity C7 which are communicated with each other, and the valve core 20 further includes a first arc-shaped plate 281 and a second arc-shaped plate 282; in the circumferential direction of the valve core 20, the first arc-shaped plate 281, the first sub-cavity C2, the second sub-cavity C3, the second arc-shaped plate 282, the third sub-cavity C6, and the fourth sub-cavity C7 are sequentially arranged; in the first working condition, the first sub-cavity C2 is communicated with the third outlet 115, and the second arc-shaped plate 282 blocks the fourth outlet 116; in the third working condition, the second sub-cavity C3 is communicated with the fourth outlet 116, and the first arc-shaped plate 281 blocks the third outlet 115; in the fourth working condition, the third sub-cavity C6 is communicated with the third outlet 115, and the first arc-shaped plate 281 blocks the fourth outlet 116; and in the sixth working condition, the fourth sub-cavity C7 is communicated with the fourth outlet 116, and the second arc-shaped plate 282 blocks the third outlet 115. In this embodiment, the each axial partition plate 273 and the each fan-shaped partition plate 274 are both connected with the shaft sleeve 271, thereby facilitating the mounting and positioning of the axial partition plate 273 and the fan-shaped partition plate 274; and the each fan-shaped partition plate 274 is connected with at least two axial partition plates 273 to ensure the limiting and supporting of the fan-shaped partition plate 274, thereby ensuring the stability and reliability of the structure.

In some embodiments, a plurality of wave ribs extending along a circumferential direction are arranged on both the first arc-shaped plate 281 and the second arc-shaped plate 282, thereby improving the structural strength and sealing effect of the valve core 20; and the wave ribs are arranged along the circumferential direction, so that the rotary resistance of the valve core 20 is reduced.

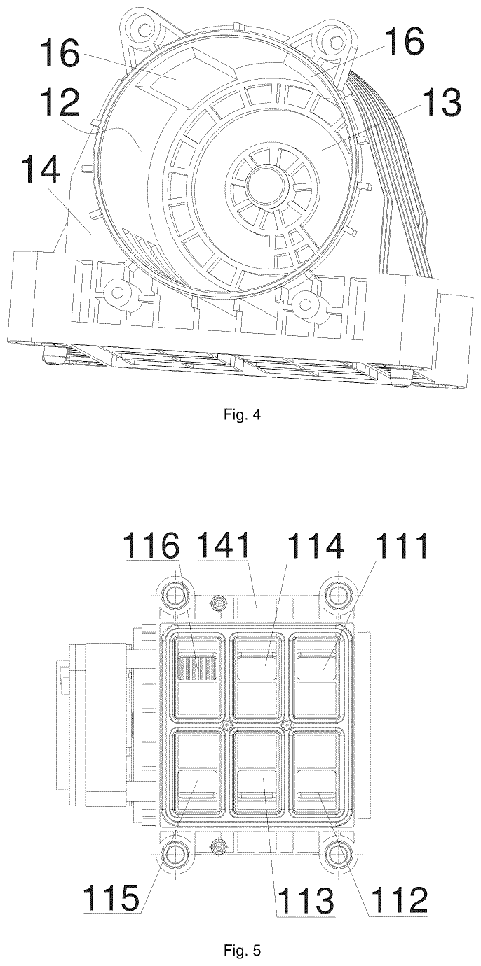

As shown in FIG. 4 to FIG. 7, a bottom wall of the valve cavity 12 is provided with an arc-shaped groove 13, the arc-shaped groove 13 is arranged around an axis of the valve core 20, the five-way valve further includes a limiting block 40, the limiting block 40 is located on a side of the valve core 20 facing the bottom wall of the valve cavity 12, and the limiting block 40 is located in the arc-shaped groove 13.

In some embodiments, the limiting block 40 and the valve core 20 are of an integrated structure and can be formed by injection molding, so that the cost can be reduced.

As shown in FIG. 16, the arc-shaped groove 13 has a first arc-shaped wall, a second arc-shaped wall, a first end wall, and a second end wall, the limiting block 40 has a fan-shaped structure, and the limiting block 40 has a third arc-shaped wall, a fourth arc-shaped wall, a third end wall, and a fourth end wall, wherein the first arc-shaped wall is matched with the third arc-shaped wall, the second arc-shaped wall is matched with the fourth arc-shaped wall, the first end wall is in stop fit with the third end wall, and the second end wall is in stop fit with the fourth end wall. By this arrangement, the limiting of rotation of the valve core 20 can be achieved by rotation of the limiting block 40 in the arc-shaped groove 13, thereby preventing the situation that the rotation angle of the valve core 20 is too large or the valve core 20 cannot be accurately reset during resetting.

In some embodiments, the valve core 20 is provided with a matching hole, the bottom wall of the valve cavity 12 is provided with a support shaft, and the support shaft penetrates into the matching hole. The support shaft and the valve body 14 are of an integrated structure.

In some embodiments, the valve core 20 has a first setting position and a second setting position; in a case that the valve core 20 is located in the first setting position, the five-way valve is in the first working condition, and the first end wall is separated from the third end wall; in a case that the valve core 20 is located in the second setting position, the five-way valve is in the sixth working condition, and the second end wall is separated from the fourth end wall; and in a case that the five-way valve is switched from the first working condition to the sixth working condition along a rotation direction, the rotation angle of the valve core 20 is N, and the range of the rotation angle of the limiting block 40 in the arc-shaped groove 13 is greater than N. This arrangement allows the range of the rotation angle of the limiting block 40 in the arc-shaped groove 13 to be greater than N, the rotation of the valve core 20 is limited by the limiting block 40 and the arc-shaped groove 13, and simultaneously, a maximum rotation range of the valve core 20 is not affected. That is, the rotation angle of the limiting block 40 in the arc-shaped groove 13 is greater than N, and the margin is located at two ends of the rotation angle N, thereby ensuring the reliability of rotation of the valve core 20 of the five-way valve.

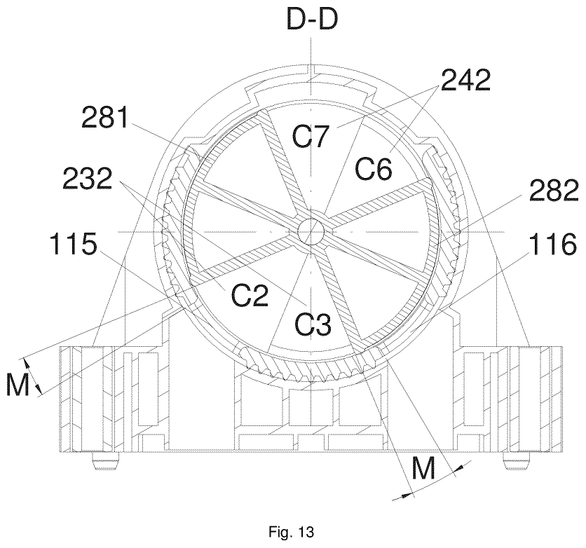

In some embodiments, the valve core 20 has a first setting position; in a case that the valve core 20 is located in the first setting position, the five-way valve is in the first working condition, and the valve core 20 has a reserved rotation angle M; in a case that the valve core 20 rotates in a range of the rotation angle M along the rotation direction from the first setting position, the five-way valve is maintained in the first working condition; and in a case that the valve core 20 rotates in a range greater than the rotation angle M along the rotation direction from the first setting position, the five-way valve is switched to other working conditions. As shown in FIG. 13, this arrangement can prevent the situation that when the valve core 20 is located in the first setting position, the valve core 20 rotates or has a mounting error so that a small part of the third outlet 115 is blocked by the first arc-shaped plate 281, and a small part of the fourth outlet 116 is opened by the second arc-shaped plate 282. Furthermore, this arrangement provides a sufficient rotation angle and rotation time required for switching the five-way valve from the first working condition to the second working condition, so that the five-way valve remains in the first working condition when the valve core 20 is in the reserved rotation angle M, a problem that the valve core 20 is affected and an inadequate rotation due to the sudden switching of the working condition is prevented.

In some embodiments, the main body portion 10 includes a valve body 14 and a sealing gasket 15, the valve body 14 has the valve cavity 12, the sealing gasket 15 is arranged in the valve cavity 12, and the first inlet 113, the second inlet 114, the first outlet 112, the second outlet 111, the third outlet 115, and the fourth outlet 116 are all arranged in the sealing gasket 15, wherein the first outlet 112, the first inlet 113, and the third outlet 115 are arranged along the axial direction of the valve core 20, the second outlet 111, the second inlet 114, and the fourth outlet 116 are arranged along the axial direction of the valve core 20, the first outlet 112 and the second outlet 111 are arranged along the circumferential direction of the valve core 20, the first inlet 113 and the second inlet 114 are arranged along the circumferential direction of the valve core 20, and the third outlet 115 and the fourth outlet 116 are arranged along the circumferential direction of the valve core 20.

Specifically, as shown in FIG. 11, an included angle between two ends of the sealing gasket 15 is 110°.

In an embodiment, as shown in FIG. 10 to FIG. 16, reserved rotation angles M=8.5°, N=225°, H1=28°, H2=62°, and H3=90°. In some embodiments, as shown in FIG. 13, an included angle between an end of the first arc-shaped plate 281 close to the third outlet 115 and a closer edge of the third outlet 115 is 8.5°, and an included angle between an end of the second arc-shaped plate 282 close to the fourth outlet 116 and a closer edge of the fourth outlet 116 is 8.5°. Specifically, the relationships between a plurality of main cavities and a plurality of cavities of the valve core 20 are shown in FIG. 8.

In some embodiments, as shown in FIG. 8, the first-first main cavity 211 includes a sub-cavity A1 and a sub-cavity A2 which are communicated with each other, the first-second main cavity 212 includes a sub-cavity B1 and a sub-cavity B2 which are communicated with each other, the third-first main cavity 231 includes a sub-cavity B3 and a sub-cavity B4 which are communicated with each other, the fourth-first main cavity 241 includes a sub-cavity B5 and a sub-cavity B6 which are communicated with each other, the second-first main cavity 221 includes a sub-cavity A7 and a sub-cavity A8 which are communicated with each other, and the second-second main cavity 222 includes a sub-cavity B7 and a sub-cavity B8 which are communicated with each other.

As shown in FIG. 11 to FIG. 16, the valve core 20 is located in the first setting position, and the rotation angle of the valve core 20 is 0°. At this time, the five-way valve is in the first working condition. At this time, the third-second main cavity 232 is communicated with the third outlet 115, the fourth outlet 116 is blocked by the second arc-shaped plate 282, the first-second main cavity 212 is communicated with the first inlet 113, the third-first main cavity 231 is communicated with the second inlet 114, the first-first main cavity 211 is communicated with the first outlet 112, the second outlet 111 is communicated with a closed cavity shown in FIG. 8 and is not communicated with other cavities, so that the second outlet 111 has no communication relationship, the third-second main cavity 232 is communicated with the third-first main cavity 231, and the first-second main cavity 212 is communicated with the first-first main cavity 211. Therefore, at this time, the second inlet 114 is communicated with the third outlet 115, and the first outlet 112 is communicated with the first inlet 113.

When the valve core 20 anticlockwise rotates 22.5° relative to the first setting position, that is, the valve core 20 rotates a reserved rotation angle M+H1/2, at this time, the five-way valve is in the second working condition, the first arc-shaped plate 281 blocks half of the third outlet 115, the second arc-shaped plate 282 on the other side also rotates this angle, half of the fourth outlet 116 is communicated with the third-second main cavity 232, and other communication relationships are not affected. At this time, the second inlet 114 is respectively communicated with the third outlet 115 and the fourth outlet 116, the proportion of the fluid entering the second inlet 114 is 100%, and the proportion of the fluids flowing out from the third outlet 115 and the fourth outlet 116 is 50% respectively. In this case, the proportion of the fluids flowing out from the third outlet 115 and the fourth outlet 116 can be adjusted by rotating the rotation angle of the valve core 20. Specifically, the flow rate adjusting range is the range of the rotation angle of the valve core 20, which is 8.5° to 36.5°. When the anticlockwise rotation angle of the valve core 20 is 8.5° to 22.5°, the proportion of the fluid flowing out from the third outlet 115 is greater than the proportion of the fluid flowing out from the fourth outlet 116. When the anticlockwise rotation angle of the valve core 20 is 22.5°, the fluid flowing out from the third outlet 115 is equal to the fluid flowing out from the fourth outlet 116. When the anticlockwise rotation angle of the valve core 20 is 22.5° to 36.5°, the proportion of the fluid flowing out from the third outlet 115 is less than the proportion of the fluid flowing out from the fourth outlet 116. When the anticlockwise rotation angle of the valve core 20 is 36.5°, the third outlet 115 is completely blocked by the first arc-shaped plate 281, and the second arc-shaped plate 282 completely avoids the fourth outlet 116; and at this time, the second inlet 114 is communicated with the fourth outlet 116, and other communication relationships remain unchanged.

When the valve core 20 anticlockwise rotates 45°, the five-way valve is in the third working condition, which is the same as the above situation when the valve core 20 anticlockwise rotates 36.5°, the third outlet 115 is completely blocked by the first arc-shaped plate 281, the second arc-shaped plate 282 completely avoids the fourth outlet 116, and other communication relationships remain unchanged; and at this time, the second inlet 114 is communicated with the fourth outlet 116, and the first outlet 112 is communicated with the first inlet 113.

When the valve core 20 anticlockwise rotates 180°, the five-way valve is in the fourth working condition. At this time, the fourth-second main cavity 242 is communicated with the third outlet 115, the fourth outlet 116 is blocked by the first arc-shaped plate 281, the fourth-first main cavity 241 is communicated with the first inlet 113, the second-second main cavity 222 is communicated with the second inlet 114, the second-first main cavity 221 is communicated with the second outlet 111, and the first outlet 112 is communicated with the closed cavity shown in FIG. 8 and is not communicated with other cavities so that the first outlet 112 has no communication relationship. Therefore, at this time, the first inlet 113 is communicated with the third outlet 115, and the second outlet 111 is communicated with the second inlet 114.

When the valve core 20 anticlockwise rotates 202.5°, the five-way valve is in the fifth working condition. At this time, with reference to FIG. 11, it can be seen that the second arc-shaped plate 282 blocks half of the third outlet 115, the first arc-shaped plate 281 on the other side communicates half of the fourth outlet 116 with the fourth-second main cavity 242, and other communication relationships are not affected. At this time, the first inlet 113 is respectively communicated with the third outlet 115 and the fourth outlet 116, the proportion of the fluid entering the first inlet 113 is 100%, and the proportion of the fluids flowing out from the third outlet 115 and the fourth outlet 116 is 50% respectively. In this case, the proportion of the fluids flowing out from the third outlet 115 and the fourth outlet 116 can be adjusted by rotating the rotation angle of the valve core 20. Specifically, the flow rate adjusting range is the range of the rotation angle of the valve core 20, which is 188.5° to 216.5°. When the anticlockwise rotation angle of the valve core 20 is 188.5° to 202.5°, the proportion of the fluid flowing out from the third outlet 115 is less than the proportion of the fluid flowing out from the fourth outlet 116. When the anticlockwise rotation angle of the valve core 20 is 202.5°, the proportion of the fluid flowing out from the third outlet 115 is equal to the proportion of the fluid flowing out from the fourth outlet 116. When the anticlockwise rotation angle of the valve core 20 is 202.5° to 216.5°, the proportion of the fluid flowing out from the third outlet 115 is greater than the proportion of the fluid flowing out from the fourth outlet 116. When the anticlockwise rotation angle of the valve core 20 is 216.5°, the second arc-shaped plate 282 completely blocks the third outlet 115, and the first arc-shaped plate 281 completely avoids the fourth outlet 116; and at this time, the first inlet 113 is communicated with the fourth outlet 116, and the second outlet 111 is communicated with the second inlet 114.

When the valve core 20 anticlockwise rotates 225°, the five-way valve is in the sixth working condition, which is the same as the above situation when the valve core 20 anticlockwise rotates 202.5°, the third outlet 115 is completely blocked by the second arc-shaped plate 282, the first arc-shaped plate 281 completely avoids the fourth outlet 116, and other communication relationships remain unchanged; and at this time, the first inlet 113 is communicated with the fourth outlet 116, and the second outlet 111 is communicated with the second inlet 114.

In some embodiments, as shown in FIG. 16, when the five-way valve is in the first working condition, the first end wall of the limiting block 40 is separated from the third end wall of the arc-shaped groove 13, a complementary angle is formed between the second end wall of the limiting block 40 and the fourth end wall of the arc-shaped groove 13, the complementary angle is 5°, and the rotation angle of the limiting block 40 in the arc-shaped groove 13 is 230°. The purpose of setting the complementary angle is to facilitate the positioning of the valve core 20 at an initial position. After the valve core 20 is mounted, first, the second end wall of the limiting block 40 on the valve core 20 can be attached to the fourth end wall of the arc-shaped groove 13, and then, the valve core 20 is integrally rotated by 5°to ensure the accuracy of the position of the valve core 20 in the first working condition. Simultaneously, the rotation angle of the valve core 20 required for switching the five-way valve from the first working condition to the sixth working condition is 225°. By setting the complementary angle which is 5°, after the valve core 20 rotates 225°, the second end wall of the limiting block 40 abuts against the fourth end wall of the arc-shaped groove 13 to limit the valve core 20, thereby preventing the valve core 20 from continuing to rotate. Furthermore, by this arrangement, after the valve core 20 rotates and resets every time, the valve core 20 is positioned again in the above manner of adjusting the initial position of the valve core 20 during mounting, thereby ensuring the reliability of the five-way valve.

In another embodiment, the complementary angle which is 5° may not be set. When the valve core 20 is located in the first setting position, that is, when the rotation angle of the valve core 20 is 0°, the second end wall of the limiting block 40 abuts against the fourth end wall of the arc-shaped groove 13. By this arrangement, the valve core 20 of the five-way valve can rotate to 230°, that is, N=230°, which facilitates the reset limiting of the position of the valve core 20 at the initial position.

Specifically, by different rotation angles of the valve core 20, the five-way valve also has multiple other communication working conditions which all play a four-way role and have no proportion adjusting relationship, so the working conditions are not listed one by one here.

As shown in FIG. 4 and FIG. 10, in some embodiments, the sealing gasket 15 has an arc-shaped structure, an outer side of the sealing gasket 15 is attached to an inner wall of the valve cavity 12, an inner side of the sealing gasket 15 is attached to an outer circumferential surface of the valve core 20, the main body portion 10 further includes two arc-shaped baffle plates 16 arranged on the inner wall of the valve cavity 12, and the two arc-shaped baffle plates 16 respectively abut against two ends of the sealing gasket 15 in the circumferential direction; and on a side of the sealing gasket 15 facing the inner wall of the valve cavity 12, the sealing gasket 15 is distributed with a plurality of sealing ribs in the axial direction and the circumferential direction. By this arrangement, the sealing gasket 15 is limited by the two arc-shaped baffle plates 16 to prevent the rotation of the sealing gasket 15 in the valve cavity 12, and the sealing gasket 15 is distributed with the plurality of sealing ribs in the axial direction and the circumferential direction, which can provide elastic margin supplementation for sealing, thereby improving the sealing reliability of the sealing gasket 15. In some embodiments, a spacing between the sealing ribs extending along the axial direction of the sealing gasket 15 is less than a spacing between the sealing ribs extending along the circumferential direction of the sealing gasket 15, thereby improving the sealing reliability.

As shown in FIG. 3, in some embodiments, the valve body 14 includes a base 141, a cylinder 142, and a plurality of reinforcing ribs 143, the cylinder 142 is connected with the base 141, each reinforcing rib 143 is connected with both the base 141 and an outer wall of the cylinder 142, the cylinder 142 has the valve cavity 12, the base 141 has six flow channels, and the six flow channels are respectively communicated with the first inlet 113, the second inlet 114, the first outlet 112, the second outlet 111, the third outlet 115, and the fourth outlet 116. By this arrangement, the six flow channels are respectively communicated with the six inlets and outlets, so that external connecting pipes are respectively communicated with the six flow channels to achieve the communication between the exterior and the five-way valve. By the arrangement of the plurality of reinforcing ribs 143, an overall structural strength of the valve body 14 is improved. Furthermore, the sealing gasket 15 is limited by the two arc-shaped baffle plates 16 arranged on the inner wall of the valve cavity 12, thereby ensuring the communication between the flow channels and the inlets and outlets, and ensuring the reliability of the five-way valve.

In some embodiments, a plurality of metal sleeves 144 are arranged in the base 141 to bear the downward locking force of bolts during a mounting process to prevent the downward locking force from concentrating on the valve body 14 and causing excessive force on the base 141 or cylinder 142 of the valve body 14, resulting in cracking. The main body portion 10 further includes a flat washer 19, the flat washer is in sealed connection with the base 141, and thus, external connecting pipes connected with flow channel openings at the positions of six flow channel openings are sealed.

In some embodiments, the main body portion 10 further includes a valve cover 17 and a sealing ring 18, the valve cover 17 is in sealed connection with the valve body 14, the valve cover 17 blocks an opening of the valve cavity 12, the sealing ring 18 is arranged in a groove of the valve cover 17, the five-way valve further includes a rotating shaft 50, a portion of the rotating shaft 50 is fixed in the valve core 20, the rotating shaft 50 passes through the sealing ring 18, and an output shaft of the single-motor actuator 30 is in driving connection with the rotating shaft 50. By this arrangement, the sealing between the valve body 14 and the valve cover 17 is achieved by the sealing ring 18 to prevent the fluid in the valve body 14 from flowing out from the valve cover 17, thereby improving the sealing performance of the five-way valve.

In some embodiments, the rotating shaft 50 penetrates into the shaft sleeve 271, the rotating shaft 50 is made of a metal material, and the valve core 20 is made of plastic.

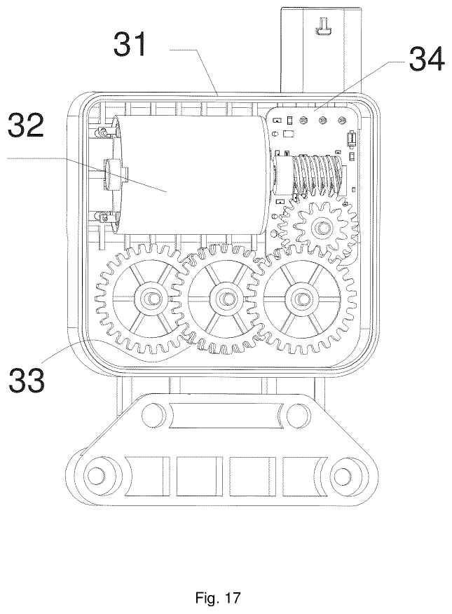

As shown in FIG. 17, in some embodiments, the single-motor actuator 30 includes a housing 31 and a motor 32, a gear assembly 33, and a control plate 34 which are arranged in the housing 31, the motor 32 is in driving connection with an input shaft of the gear assembly 33, an output shaft of the gear assembly 33 is in driving connection with the valve core 20, and the housing 31 is fixedly connected with the main body portion 10. By this arrangement, a control device is combined with a driving device to form the single-motor actuator 30, thereby reducing the processing and manufacturing cost of the five-way valve. Furthermore, the single-motor actuator 30 drives the valve core 20 to rotate mainly through the gear assembly 33, the structure is simple, and the transmission is reliable.

The above descriptions are only some embodiments of the present disclosure, but are not intended to limit the present disclosure. It will be apparent to those skilled in the art that various modifications and changes can be made in the present disclosure. Any modifications, equivalent replacements, improvements, and the like made within the spirit and principle of the present disclosure shall be included within the protection scope of the present disclosure.

What is claimed is:

1. A five-way valve, comprising:
a main body portion, the main body portion having a valve cavity, a first inlet, a second inlet a first outlet, a second outlet, a third outlet, and a fourth outlet;
a valve core rotatably arranged in the valve cavity, the valve core having a first cavity, a second cavity, a third cavity, and a fourth cavity which are separated; and
a single-motor actuator, the single-motor actuator being in driving connection with the valve core, wherein the five-way valve can be switched to any one of following working conditions by means of rotation of the valve core;
a first working condition: the first inlet is communicated with the first outlet through the first cavity, the second inlet is communicated with the third outlet through the third cavity, and the second outlet and the fourth outlet are disconnected;
a second working condition: the first inlet is communicated with the first outlet through the first cavity, the second inlet is communicated with both the third outlet and the fourth outlet through the third cavity and the second outlet is disconnected;
a third working condition: the first inlet is communicated with the first outlet through the first cavity, the second inlet is communicated with the fourth outlet through the third cavity, and both the third outlet and the second outlet are disconnected;
a fourth working condition: the second inlet is communicated with the second outlet through the second cavity, the first inlet is communicated with the third outlet through the fourth cavity and both the first outlet and the fourth outlet are disconnected;
a fifth working condition: the second inlet is communicated with the second outlet through the second cavity, the first inlet is communicated with both the third outlet and the fourth outlet through the fourth cavity and the first outlet is disconnected; and
a sixth working condition: the second inlet is communicated with the second outlet through the second cavity, the first inlet is communicated with the fourth outlet through the fourth cavity, and the first outlet and the third outlet are disconnected.

2. The five-way valve as claimed in claim 1, wherein
in the second working condition, the single-motor actuator is configured to drive the valve core to rotate and maintain at multiple different positions to adjust a proportion of fluids output from the third outlet and the fourth outlet and in the fifth working condition, the single-motor actuator is configured to drive the valve core to rotate and maintain at multiple different positions to adjust a proportion of fluids output from the third outlet and the fourth outlet-(116).

3. The five-way valve as claimed in claim 1, wherein the valve core comprises a first axial region, a second axial region and a third axial region which are sequentially arranged in an axial direction, and openings of the first cavity, the second cavity, the third cavity and the fourth cavity all face an inner wall of the valve cavity; and
the first cavity comprises a first-first main cavity and a first-second main cavity which are communicated with each other, the third cavity comprises a third-first main cavity and a third-second main cavity which are communicated with each other, the second cavity comprises a second-first main cavity and a second-second main cavity which are communicated with each other, and the fourth cavity comprises a fourth-first main cavity and a fourth-second main cavity which are communicated with each other,
wherein the first-first main cavity and the second-first main cavity are both located in the first axial region, the first-second main cavity, the third-first main cavity, the fourth-first main cavity, and the second-second main cavity are all located in the second axial region and the third-second main cavity and the fourth-second main cavity are both arranged in the third axial region.

4. The five-way valve as claimed in claim 3, wherein the valve core comprises a first fan-shaped region a second fan-shaped region, a third fan-shaped region, a fourth fan-shaped region, a fifth fan-shaped region, a sixth fan-shaped region a seventh fan-shaped region and an eighth fan-shaped region which are sequentially arranged in a circumferential direction, wherein the first-first main cavity is distributed in the first fan-shaped region and the second fan-shaped region, the first-second main cavity is distributed in the first fan-shaped region and the second fan-shaped region the third-first main cavity is distributed in the third fan-shaped region and the fourth fan-shaped region the third-second main cavity is distributed in the second fan-shaped region and the third fan-shaped region, the second-first main cavity is distributed in the seventh fan-shaped region and the eighth fan-shaped region, the second-second main cavity is distributed in the seventh fan-shaped region and the eighth fan-shaped region, the fourth-first main cavity is distributed in the fifth fan-shaped region and the sixth fan-shaped region, and the fourth-second main cavity is distributed in the sixth fan-shaped region and the seventh fan-shaped region.

5. The five-way valve as claimed in claim 4, wherein in the axial direction of the valve core, lengths of the first axial region, the second axial region. and the third axial region are equal; and in the circumferential direction of the valve core, radians of the first fan-shaped region, the second fan-shaped region the third fan-shaped region the fourth fan-shaped region, the fifth fan-shaped region, the sixth fan-shaped region the seventh fan-shaped region and the eighth fan-shaped region are equal.

6. The five-way valve as claimed in claim 3, wherein in a circumferential direction of the valve core opening angles of the third outlet and the fourth outlet are both H1, a spacing angle between the third outlet and the fourth outlet is H2, and opening angles of the third-second main cavity and the fourth-second main cavity are both H3, wherein

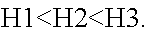

7. The five-way valve as claimed in claim 3, wherein the valve core comprises a shaft sleeve, two circular end plates, a plurality of axial partition plates, and a plurality of fan-shaped partition plates, the two circular end plates are arranged in parallel and are both fixedly connected with the shaft sleeve, and the two circular end plates and the shaft sleeve are both coaxially arranged, wherein the plurality of axial partition plates and the plurality of fan-shaped partition plates are distributed in a space between the two circular end plates to divide the space between the two circular end plates into the first cavity, the second cavity the third cavity, and the fourth cavity, and the single-motor actuator is in driving connection with the shaft sleeve.

8. The five-way valve as claimed in claim 7, wherein each of the plurality of axial partition plates and each of the plurality of fan-shaped partition plates are both connected with the shaft sleeve, and the each of the plurality of fan-shaped partition plates is connected with at least two axial partition plates in the plurality of axial partition plates;
the third-second main cavity comprises a first sub-cavity and a second sub-cavity which are communicated with each other, the fourth-second main cavity comprises a third sub-cavity and a fourth sub-cavity which are communicated with each other, and the valve core further comprises a first arc-shaped plate and a second arc-shaped plate in a circumferential direction of the valve core, the first arc-shaped plate, the first sub-cavity, the second sub-cavity, the second arc-shaped plate the third sub-cavity, and the fourth sub-cavity are sequentially arranged;
in the first working condition, the first sub-cavity is connected to the third outlet and the second arc-shaped plate blocks the fourth outlet
in the third working condition, the second sub-cavity is connected to the fourth outlet, and the first arc-shaped plate blocks the third outlet
in the fourth working condition, the third sub-cavity is connected to the third outlet and the first arc-shaped plate blocks the fourth outlet; and
in the sixth working condition, the fourth sub-cavity is connected to the fourth outlet, and the second arc-shaped plate blocks the third outlet

9. The five-way valve as claimed in claim 1, wherein a bottom wall of the valve cavity is provided with an arc-shaped groove, the arc-shaped groove is arranged around an axis of the valve core, the five-way valve further comprises a limiting block, the limiting block is located on a side of the valve core facing the bottom wall of the valve cavity, and the limiting block is located in the arc-shaped groove.

10. The five-way valve as claimed in claim 9, wherein the arc-shaped groove has a first arc-shaped wall, a second arc-shaped wall, a first end wall, and a second end wall, the limiting block has a fan-shaped structure, and the limiting block has a third arc-shaped wall, a fourth arc-shaped wall, a third end wall, and a fourth end wall, wherein the first arc-shaped wall is matched with the third arc-shaped wall, the second arc-shaped wall is matched with the fourth arc-shaped wall, the first end wall is in stop fit with the third end wall, and the second end wall is in stop fit with the fourth end wall.

11. The five-way valve as claimed in claim 10, wherein
the valve core has a first setting position and a second setting position; in a case that the valve core is located in the first setting position, the five-way valve is in the first working condition, and the first end wall is separated from the third end wall; in a case that the valve core is located in the second setting position, the five-way valve is in the sixth working condition, and the second end wall is separated from the fourth end wall; and
in a case that the five-way valve is switched from the first working condition to the sixth working condition along a rotation direction, a rotation angle of the valve core is N, and a range of a rotation angle of the limiting block in the arc-shaped groove is greater than N.

12. The five-way valve as claimed in claim 1, wherein the valve core has a first setting position; in a case that the valve core is located in the first setting position, the five-way valve is in the first working condition, and the valve core has a reserved rotation angle M; in a case that the valve core rotates in a range of the rotation angle M along a rotation direction from the first setting position, the five-way valve is maintained in the first working condition; and in a case that the valve core rotates in a range greater than the rotation angle M along the rotation direction from the first setting position, the five-way valve is switched to other working conditions.

13. The five-way valve as claimed in any one of claim 1, wherein
the main body portion comprises a valve body and a sealing gasket, the valve body has the valve cavity, the sealing gasket is arranged in the valve cavity, and the first inlet, the second inlet the first outlet, the second outlet, the third outlet and the fourth outlet are all arranged in the sealing gasket; and
the first outlet, the first inlet and the third outlet are arranged along an axial direction of the valve core, the second outlet, the second inlet and the fourth outlet are arranged along the axial direction of the valve core, the first outlet and the second outlet are arranged along a circumferential direction of the valve core, the first inlet and the second inlet are arranged along the circumferential direction of the valve core, and the third outlet and the fourth outlet are arranged along the circumferential direction of the valve core.

14. The five-way valve as claimed in claim 13, wherein the sealing gasket has an arc-shaped structure, an outer side of the sealing gasket is attached to an inner wall of the valve cavity an inner side of the sealing gasket is attached to an outer circumferential surface of the valve core, the main body portion further comprises two arc-shaped baffle plates arranged on the inner wall of the valve cavity, and the two arc-shaped baffle plates respectively abut against two ends of the sealing gasket in a circumferential direction; and on a side of the sealing gasket facing the inner wall of the valve cavity, the sealing gasket is distributed with a plurality of sealing ribs in the axial direction and the circumferential direction.

15. The five-way valve as claimed in claim 13, wherein the valve body comprises a base a cylinder and a plurality of reinforcing ribs, the cylinder is connected with the base each of the plurality of reinforcing ribs is connected with both the base and an outer wall of the cylinder, the cylinder has the valve cavity, the base has six flow channels, and the six flow channels are respectively communicated with the first inlet the second inlet, the first outlet the second outlet, the third outlet, and the fourth outlet

16. The five-way valve as claimed in claim 13, wherein the main body portion further comprises a valve cover and a sealing ring the valve cover is in sealed connection with the valve body the valve cover blocks an opening of the valve cavity, the sealing ring is arranged in a groove of the valve cover, the five-way valve further comprises a rotating shaft, a portion of the rotating shaft is fixed in the valve core, the rotating shaft passes through the sealing ring, and an output shaft of the single-motor actuator is in driving connection with the rotating shaft

17. The five-way valve as claimed in claim 1, wherein the single-motor actuator comprises a housing and a motor, a gear assembly, and a control plate which are arranged in the housing the motor is in driving connection with an input shaft of the gear assembly, an output shaft of the gear assembly is in driving connection with the valve core and the housing is fixedly connected with the main body portion.
